(19) United States
(12) Patent Application Publication
(10) Pub. No.: US 2005/0067949 A1
(43) Pub. Date: Mar. 31, 2005

(54) Solvent mixtures for an organic electronic device

(76) Inventors: Sriram Natarajan, Burlingame, CA (US); Andrew Ingle, Fremont, CA (US); Rahul Gupta, Santa Clara, CA (US)

Correspondence Address: Siemens Corporation;Attn: Elsa Keller, Legal Administrator, Intellectual Property Department, 170 Wood Avenue South, Iselin, NJ, 08830, US

(21) Appl. No.: 10/676,434

(22) Filed: Sep. 30, 2003

(51) Int. Cl. H05B 33/14; H05B 33/10

(52) U.S. Cl. 313/504; 313/503; 313/506; 427/66; 445/24

(57) ABSTRACT

An organic polymer solution is made of at least one organic polymer, a first solvent, and a second solvent. The first solvent has a high solubility (e.g., the first solvent dissolves at least about one weight percent of the organic polymers) and has a faster evaporation rate than the second solvent, and the second solvent has a very low solubility (e.g., the second solvent dissolves less than about one-fourth weight percent of the organic polymers). After the solution is deposited on an object, the solution is allowed to dry. As the solution dries, the first solvent due to its faster evaporation rate than the second solvent starts to evaporate from the solution, and soon after the first solvent starts to evaporate, the one or more organic polymers, due to its lower solubility in the second solvent, rapidly gels resulting in a substantially uniform organic polymer layer.

### BACKGROUND OF THE INVENTION

An organic light emitting diode (“OLED”) is typically comprised of one or more thin organic layers (e.g., a hole transporting layer (“HTL”) and an emissive polymer layer) separating its anode and cathode. Under an applied forward potential, the anode injects holes into the HTL, while the cathode injects electrons into the emissive polymer layer. The injected holes and electrons each migrate toward the oppositely charged electrode and recombine to form an exciton in the emissive polymer layer. The exciton then transitions from an excited state to a ground state and in the process, emits light.

The one or more organic layers can be formed by selective deposition techniques (e.g., ink jet printing, flex printing, or screen printing) or nonselective deposition techniques (e.g., spin coating, dip coating, web coating, or spray coating). If the layer is formed using nonselective deposition techniques, then in order to pattern the layer, photolithography techniques are typically employed. The photolithography techniques have disadvantages such as complicated steps, and the consumption and waste of large amounts of materials. Because of these and other disadvantages, selective deposition techniques have been examined to deposit organic materials. Ink-jet printing devices are especially favored since such modern day industrial printers can easily deposit a pattern of thin/thick films over a large area in a short time with high precision.

FIG. 1 shows a prior art ink-jet printing system used to deposit a solution. In FIG. 1, the OLED display that is being fabricated includes a substrate 109 and an anode 112 on the substrate 109. Bank structures 115 are on the anode 112; the bank structure has apertures 118 through which the anode is exposed (the apertures 118 can be pockets or lines). HTLs 121 are on the exposed portions of the anode 112. Emissive polymer layers 122 are on the HTLs 121. Here, the emissive polymer layers 122 are formed by discharging droplets 124 of a solution that includes emissive polymers onto the HTLs and then allowing this emissive polymer solution to dry. The emissive polymer solution is discharged through nozzles 127 of printhead 130.

When the emissive polymer solution dries, the resulting emissive polymer layer has a nonuniform profile. FIG. 2 shows the profile of the prior art solution after it is deposited into the aperture of the bank structure but prior to evaporation of the solvents, and the profile of the resulting layer after the prior art solution is allowed to dry. As seen in FIG. 2, the resulting polymer layer has a concave shape (i.e., a nonuniform shape) and there is substantial pileup of the polymers at the edges of the bank structure. The pileup of the polymers at the edges of the bank structure is due to the polymers in the solution diffusing to the edges. The diffusion is due to differences in surface tensions that are caused by the differences in the rate of evaporation of the solvent from the emissive polymer solution at different regions of the aperture 118. This difference causes the substance to move towards the edges of the aperture 118 from the middle, as the edges have a faster evaporation rate (lower surface tension) than the middle, and hence the ultimate deposition of more of the substance at the edge than in the middle. This phenomenon is usually referred to as the Marangoni effect. A common example of this phenomenon is the drying of a coffee stain which shows more prominence (is darker in color) on the edges of the stain than in the center. The degree of pileup is controlled by the rate of diffusion of the polymer and the rate of evaporation of the solvent. If the increase in the viscosity of the solution due to the evaporation of the solvent is slow relative to the time it takes the material to diffuse from the middle of the aperture 118 to the edge, the polymer has ample time to diffuse to the edges from the center and this results in a large pileup and non-uniformity in the thickness of the deposited film.

If the layer is non-uniform, then the electric field across the layer will also be non-uniform (the electric field is inversely proportional to the thickness of the film). The non-uniform electric field results in non-uniform electric current passing through the layer with less current in the thicker regions near the edges and more current in the thinner regions near the center of the layer. The non-uniform current across the layer results in non-uniform light emission across the layer. Also, the higher current at the thinner regions makes these regions more vulnerable to electric shorts which can render the OLED unusable. The higher current density is expected to increase the rate of degradation of the device and lead to a lower overall lifetime of the device.

For the foregoing reasons, there exists a need to form a substantially uniform polymer layer in order to, for example, improve device performance and device lifetime.

### SUMMARY

An embodiment of a method is described to form a substantially uniform organic polymer layer on an object. The method includes mixing at least one organic polymer in a first solvent and a second solvent to form an organic polymer solution. The first solvent has a high solubility and a faster evaporation rate than the second solvent, and the second solvent has a very low solubility. The method also includes effectively depositing the solution on the object, and allowing the solution to dry to form a substantially uniform organic polymer layer on the object.

An embodiment of an organic polymer solution is also described. The solution includes at least one organic polymer, a first solvent, and a second solvent. The first solvent has a high solubility and a faster rate of evaporation than the second solvent, and the second solvent has a very low solubility.

### BRIEF DESCRIPTION OF THE DRAWINGS

FIG. 1 shows a prior art ink-jet printing system used to deposit a solution.

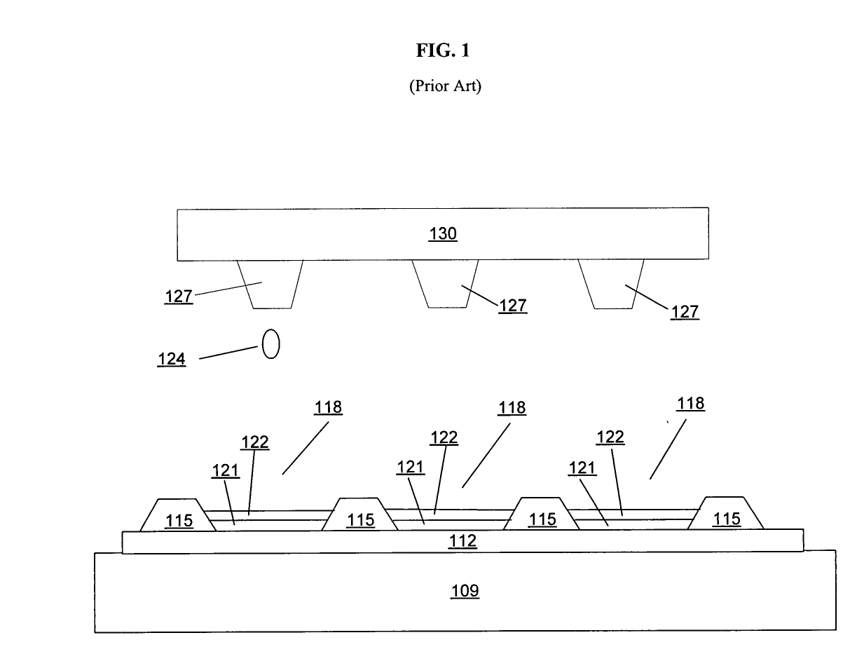

FIG. 2 shows the profile of the prior art solution after it is deposited into the aperture of the bank structure but prior to evaporation of the solvents, and the profile of the resulting layer after the prior art solution is allowed to dry.

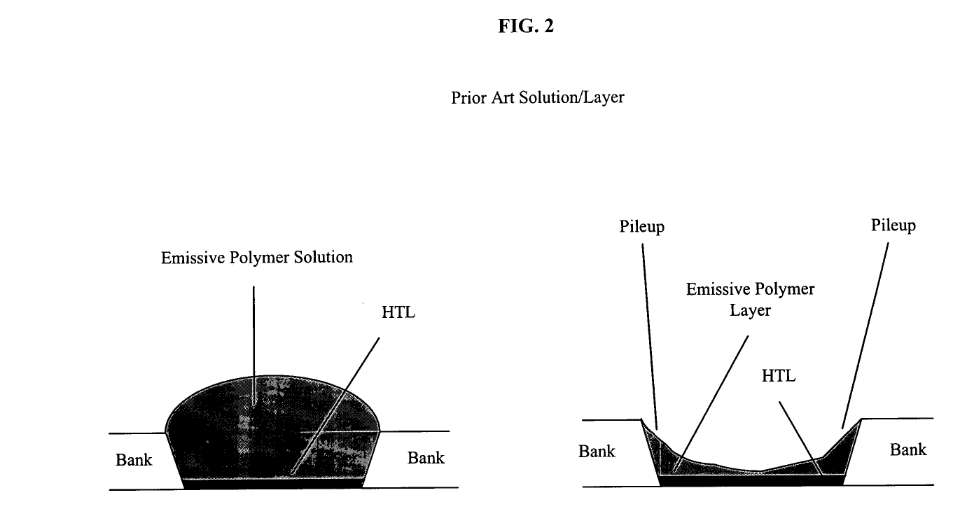

FIG. 3 shows a cross-sectional view of an embodiment of an organic electronic device according to the present invention.

FIG. 4 shows the profile of the embodiment of the solution according to the present invention after it is deposited into the aperture of the bank structure but prior to evaporation of the solvents, and the profile of the resulting layer after the embodiment of the claimed solution is allowed to dry.

FIG. 5 compares the profiles of the resulting layers formed by the prior art solution and the embodiment of the claimed solution.

FIG. 6 shows photoluminescence images of the resulting layer formed by the prior art solution and the resulting layer formed by the embodiment of the solution according to the present invention.

FIG. 7 shows a flowchart of an embodiment of a process to fabricate an organic electronic device according to the present invention.

### DETAILED DESCRIPTION

The one or more solvents used to dissolve the organic polymers are one of the important factors determining the uniformity or flatness of the resulting dried layer. The uniformity of the resulting layer can be controlled by the solvents used to dissolve the organic polymers. An organic polymer solution is made by mixing together at least one organic polymer and a first solvent, and then adding a second solvent to the mixture. Alternatively, the solution can be made by mixing the first solvent and the second solvent and then adding the one or more polymers to the mixture. The first solvent has a high solubility (e.g., the first solvent dissolves at least about one weight percent of the organic polymers) and a faster evaporation rate than the second solvent, and the second solvent has a very low solubility (e.g., the second solvent dissolves less than about one-fourth weight percent of the organic polymers). The first solvent can have a lower boiling point than the second solvent. For example, the first solvent can have a boiling point less than about 150° C. and the second solvent can have a boiling point greater than about 200° C. The solution is deposited on a layer and allowed to dry. As the solution dries, the first solvent, due to its faster rate of evaporation, starts to evaporate from the solution, and soon after the first solvent starts to evaporate, the organic polymers, due to its lower solubility in the second solvent, rapidly falls out of solution and gels. By gelling rapidly, the rapid increase in local viscosity of the polymer solution substantially reduces the diffusion rate of the polymers, thus limiting the transport of the polymers and producing a substantially uniform (i.e., flat) organic polymer layer. As the solution dries, the second solvent also evaporates but it evaporates at a much slower rate than the first solvent. In one configuration, a layer is considered to be substantially uniform if 70% of the width of the layer is within a thickness variation of ±15%, preferably within a thickness variation of ±5%. If the layer is substantially uniform, then the device performance and the device lifetime are improved.

The first solvent can be, for example: toluene, chlorobenzene, ethyl benzene, xylene, cumene, anisole, or mesitylene. The second solvent can be, for example: decalin, tetramethyl benzene, N-methyl-pyrrolidone, pentyl benzene, gamma butyrolactone, alpha-terpineol, propylene, carbonate, or methylnaphthalene. Examples of organic polymers are listed below in the section “Substantially Uniform Organic Polymer Layer 320”.

In addition, the solution may include a third solvent that has a low surface tension; the third solvent is added to the solution to improve the spreading of the polymer solution on the substrate (in the aperture 118) so that the one or more polymers in solution completely fill the aperture 118. The third solvent could be less than about twenty weight percent of the solution, preferably, less than about ten weight percent of the solution. The third solvent has a surface tension that is, for example, less than 30 dynes/cm.

The organic polymer solution can be deposited on an object (e.g., the object can be, for example, a substrate, an anode, or a hole transporting layer) using deposition techniques such as, for example, ink jet printing, spin coating, screen printing, or roll coating. The deposited organic polymer solution dries to form the substantially uniform organic polymer layer.

Examples of organic electronic devices are an OLED, an organic transistor or circuits made thereof, an organic light detector, an organic solar cell, or an organic laser. Organic electronic devices use the organic polymer layer to, for example, convert electrical energy to light energy (e.g., this occurs in the OLED), or to convert light energy to electrical energy (e.g., this occurs in the solar cell or the light detector).

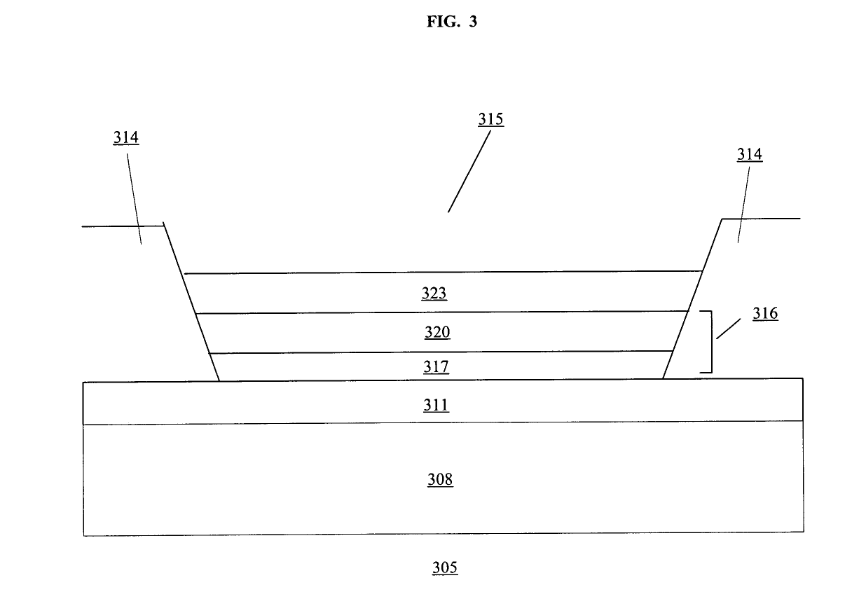

FIG. 3 shows a cross-sectional view of an embodiment of an organic electronic device 305 according to the present invention. As shown in FIG. 3, the organic electronic device 305 includes a first electrode 311 on a substrate 308. As used within the specification and the claims, the term “on” includes when layers are in physical contact and when layers are separated by one or more intervening layers. The first electrode 311 may be patterned for pixilated applications or unpatterned for backlight applications. If the electronic device 305 is a transistor, then the first electrode may be, for example, the source and drain contacts of that transistor. A photo-resist material is deposited on the first electrode 311 and patterned to form a bank structure 314 having an aperture 315 that exposes the first electrode 311. The aperture 315 may be a pocket (e.g., a pixel of an OLED display) or a line. The bank structure 314 is an insulating structure that electrically isolates one pocket from another pocket or one line from another line. One or more organic materials is deposited into the aperture 315 to form one or more organic layers of an organic stack 316. The organic stack 316 is on the first electrode 311. The organic stack 316 includes a substantially uniform organic polymer layer 320 and an optional hole transporting layer (“HTL”) 317. If the first electrode 311 is an anode, then the substantially uniform organic polymer layer 320 is on the HTL 317 if present (as shown), or the layer 320 is on the first electrode if the HTL 317 is not present (not shown). Alternatively, if the first electrode 311 is a cathode, then the substantially uniform organic polymer layer 320 is on the first electrode 311, and the HTL 317 if present is on the substantially uniform organic polymer layer 320. The electronic device 305 also includes a second electrode 323 on the organic stack 316. If the electronic device 305 is a transistor, then the second electrode 323 may be, for example, the gate contact of that transistor. Other layers than that shown in FIG. 3 may also be added including insulating layers between the first electrode 311 and the organic stack 316, and/or between the organic stack 316 and the second electrode 323. Some of these layers are described in greater detail below.

Substrate 308:

The substrate 308 can be any material that can support the layers on it. The substrate 308 can be transparent or opaque (e.g., the opaque substrate is used in top-emitting devices). By modifying or filtering the wavelength of light which can pass through the substrate 308, the color of light emitted by the device can be changed. The substrate 308 can be comprised of glass, quartz, silicon, plastic, or stainless steel; preferably, the substrate 308 is comprised of thin, flexible glass. The preferred thickness of the substrate 308 depends on the material used and on the application of the device. The substrate 308 can be in the form of a sheet or continuous film. The continuous film is used, for example, for roll-to-roll manufacturing processes which are particularly suited for plastic, metal, and metallized plastic foils. The substrate can also have transistors or other switching elements built in to control the operation of the device.

First Electrode 311:

In one configuration of this embodiment, the first electrode 311 functions as an anode (the anode is a conductive layer which serves as a hole-injecting layer and which comprises a material with work function greater than about 4.5 eV). Typical anode materials include metals (such as platinum, gold, palladium, indium, and the like); metal oxides (such as lead oxide, tin oxide, ITO, and the like); graphite; doped inorganic semiconductors (such as silicon, germanium, gallium arsenide, and the like); and doped conducting polymers (such as polyaniline, polypyrrole, polythiophene, and the like).

In an alternative configuration, the first electrode layer 311 functions as a cathode (the cathode is a conductive layer which serves as an electron-injecting layer and which comprises a material with a low work function). The cathode, rather than the anode, is deposited on the substrate 308 in the case of, for example, a top-emitting OLED. Typical cathode materials are listed below in the section for the “second electrode 323”.

The first electrode 311 can be transparent, semi-transparent, or opaque to the wavelength of light generated within the device. The thickness of the first electrode 311 is from about 10 nm to about 1000 nm, preferably, from about 50 nm to about 200 nm, and more preferably, is about 100 nm.

The first electrode layer 311 can typically be fabricated using any of the techniques known in the art for deposition of thin films, including, for example, vacuum evaporation, sputtering, electron beam deposition, or chemical vapor deposition.

Bank Structure 314:

The bank structure 314 is made of a photo-resist material such as, for example, polyimides or polysiloxanes. The photo-resist material can be either positive photo-resist material or negative photo-resist material. The bank structure 314 is an insulating structure that electrically isolates one pocket from another pocket or one line from another line. The bank structure 314 has an aperture 315 that exposes the first electrode 311. The aperture 315 may represent a pocket or a line. The bank structure 314 is patterned by applying lithography techniques to the photo-resist material, or by using screen printing or flexo-printing to deposit the bank material in the desired pattern.

As shown in FIG. 3, the bank structure 314 can have, for example, a trapezoidal configuration in which the angle between the side wall of the bank structure 314 and the first electrode 311 is an obtuse angle.

HTL 317:

The HTL 317 has a much higher hole mobility than electron mobility and is used to effectively transport holes from the first electrode 311 to the substantially uniform organic polymer layer 320. The HTL 217 is made of polymers or small molecule materials. For example, the HTL 217 can be made of tertiary amine or carbazole derivatives both in their small molecule or their polymer form, conducting polyaniline (“PANI”), or polyethylenedioxythiophene-polystyrenesulfonate (“PEDOT:PSS”).

The HTL 317 functions as: (1) a buffer to provide a good bond to the substrate; and/or (2) a hole injection layer to promote hole injection; and/or (3) a hole transport layer to promote hole transport.

The HTL 317 has a thickness from about 5 nm to about 1000 nm, preferably from about 20 nm to about 500 nm, and more preferably from about 50 to about 250 nm.

The HTL 317 can be deposited using selective deposition techniques or nonselective deposition techniques. Examples of selective deposition techniques include, for example, ink jet printing, flex printing, and screen printing. Examples of nonselective deposition techniques include, for example, spin coating, dip coating, web coating, and spray coating. If printing techniques are used, then the hole transporting material is deposited on the first electrode 311 and then allowed to dry. The dried material represents the hole transport layer.

Substantially Uniform Organic Polymer Layer 320:

The substantially uniform organic polymer layer 320 is formed from a solution that includes one or more organic polymers, a first solvent, and a second solvent. The first solvent has a high solubility (e.g., the first solvent dissolves at least about one weight percent of the organic polymers) and a faster evaporation rate than the second solvent, and the second solvent has a very low solubility (e.g., the second solvent dissolves less than about one-fourth weight percent of the organic polymers). The first solvent can have a lower boiling point than the second solvent. For example, the first solvent can have a boiling point less than about 150° C. and the second solvent can have a boiling point greater than about 200° C. The solution is deposited on a layer (e.g., this layer can be the first electrode 311 or the hole transporting layer 317) and allowed to dry. As the solution dries, the first solvent, due to its faster rate of evaporation than the second solvent, starts to evaporate from the solution, and soon after the first solvent starts to evaporate, the organic polymers, due to its lower solubility in the second solvent, rapidly falls out of solution and gels resulting in the substantially uniform organic polymer layer 320. By gelling rapidly, the rapid increase in local viscosity of the polymer solution substantially reduces the diffusion rate of the polymer, thus limiting the transport of the polymers and producing a substantially uniform (i.e., flat) organic polymer layer. As the solution dries, the second solvent also evaporates but it evaporates at a much slower rate than the first solvent. The solubility of the second solvent should be as low as possible so that the polymers gel as rapidly as possible.

The solution can be deposited on the layer by, for example, ink jet printing where nozzles of an ink jet printhead discharge droplets of the solution into the apertures of the bank structures. Alternatively, the solution can be deposited on the layer by spin coating; in this case, an excess amount of the solution is deposited on the center of the substrate and then the device is rotated so that centrifugal force spreads the solution uniformly across the active area of the apertures of the bank structures. Other deposition techniques such as, for example, screen printing or roll coating can also be used to deposit the solution.

Preferably, the amount of the first solvent in the solution is adjusted so that it is the minimum amount for a stable solution. In other words, there is enough of the first solvent so that the polymers will stay in solution until the solution is discharged, or it will stay in solution until the solution is uniformly spread across the active area of the apertures of the bank structures. Preferably, there is enough of the first solvent so that the solution has the shelf life required for a reliable manufacturing process. However, there should not be too much of the first solvent such that the polymers are in solution for a time period that would allow the polymers in the solution to diffuse to the edges eventually resulting in a build-up of the polymers at the edges. The stable solution allows, for example, the solution to be discharged from a nozzle of the ink-jet printhead without clogging the nozzle during discharge. Alternatively, the solution is stable until it is uniformly distributed across the active area of the apertures of the bank structures by spin coating.

The first solvent can be, for example: toluene, chlorobenzene, ethyl benzene, xylene, cumene, anisole, or mesitylene. The second solvent can be, for example: decalin, tetramethyl benzene, N-methyl-pyrrolidone, pentyl benzene, gamma butyrolactone, alpha-terpineol, propylene, carbonate, or methylnaphthalene.

If the organic electronic device is an OLED or an organic laser, then the organic polymers are electroluminescent (“EL”) polymers that emit light. The light emitting organic polymers can be, for example, EL polymers having a conjugated repeating unit, in particular EL polymers in which neighboring repeating units are bonded in a conjugated manner, such as polythiophenes, polyphenylenes, polythiophenevinylenes, or poly-p-phenylenevinylenes or their families, copolymers, derivatives, or mixtures thereof. More specifically, the organic polymers can be, for example: polyfluorenes; poly-p-phenylenevinylenes that emit white, red, blue, yellow, or green light and are 2-, or 2,5-substituted poly-p-pheneylenevinylenes; polyspiro polymers; LUMATION polymers that emit green, red, blue, or white light and are produced by Dow Chemical, Midland Mich.; or their families, copolymers, derivatives, or mixtures thereof.

If the organic electronic device is an organic solar cell or an organic light detector, then the organic polymers are light responsive material that changes its electrical properties in response to the absorption of light. The light responsive material converts light energy to electrical energy.

If the organic electronic device is an organic transistor, then the organic polymers can be, for example, polymeric and/or oligomeric semiconductors. The polymeric semiconductor can comprise, for example, polythiophene, poly(3-alkyl)thiophene, polythienylenevinylene, poly(para-phenylenevinylene), or polyfluorenes or their families, copolymers, derivatives, or mixtures thereof.

In addition, a third solvent with a low surface tension may be added to the solution to increase spreading of the polymer solution on the substrate (in the aperture 118) so that the polymers in solution completely fills the aperture 118.

The thickness of the resulting substantially uniform organic polymer layer 320 is from about 5 nm to about 500 nm, preferably, from about 20 nm to about 100 nm, and more preferably from about 70 nm to about 100 nm.

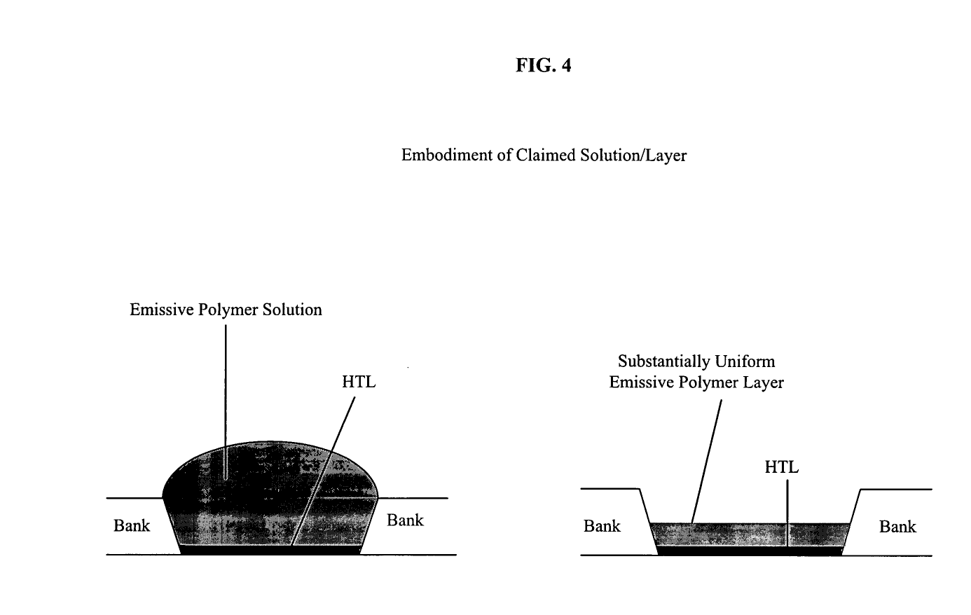

FIGS. 4-6 show some characteristics of partially fabricated OLEDs in which the emissive polymer layers are formed from an embodiment of the claimed solution. The example OLEDs described below are presented for a further understanding of the invention and should not be construed as limiting the scope of the appended claims or their equivalents.

FIG. 4 shows the profile of the embodiment of the solution according to the present invention after it is deposited into the aperture of the bank structure but prior to evaporation of the solvents, and the profile of the resulting layer after the embodiment of the claimed solution is allowed to dry. An OLED display was partially fabricated by depositing a layer of indium tin oxide (“ITO”)(not shown) on a glass substrate (not shown). Then, bank structures having apertures were formed on the ITO. A polyethylenedioxythiophene-polystyrenesulfonate (PEDOT:PSS) layer was formed on the exposed portions of the ITO. These steps of fabricating the OLED display are well known to those skilled in the art. The embodiment of the claimed solution was deposited by ink jet printing into the pocket (i.e., the aperture of the bank structure). As the embodiment of the claimed solution dried, the first solvent started to evaporate from the solution, and soon after, the polymer fell out of solution and gelled rapidly causing a rapid increase in the viscosity of the polymer solution and this prevented a diffusion of the polymers to the edge of the aperture and prevented the pile-up (i.e., build up) of the polymers at the edges of the aperture. As shown in FIG. 4 and observed in other experiments, the effect of using the embodiment of the claimed solution is that when the solution dries, the resulting layer is substantially uniform and flat with only very minimal pile-up at the edges of the banks.

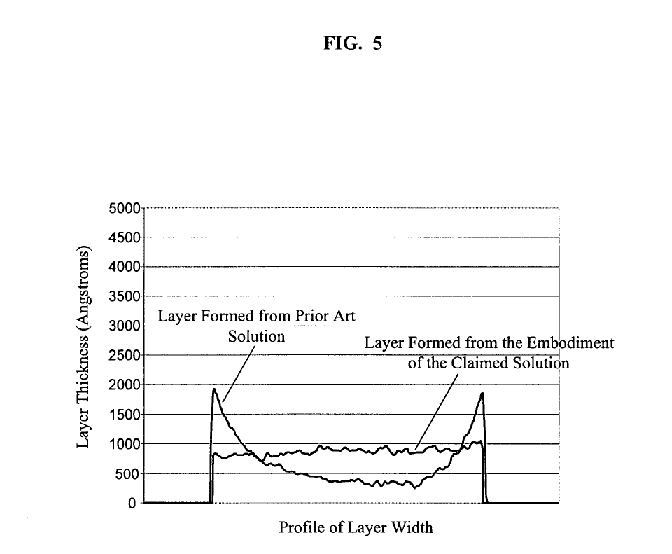

FIG. 5 compares the profiles of the resulting layers formed by the prior art solution and the embodiment of the claimed solution. A prior art OLED display was partially fabricated by depositing a layer of ITO on a glass substrate. Then, bank structures having apertures were formed on the ITO. A PEDOT:PSS layer was formed on exposed portions of the ITO. A prior art electroluminescent layer was formed on the PEDOT:PSS layer using a prior art solution that included xylene as the solvent and the organic polymers were the LUMATION polymers that emit green, red, or blue light.

In addition, an embodiment of the OLED display according to the present invention was partially fabricated by depositing a layer of ITO on a glass substrate. Then, bank structures having apertures were formed on the ITO. A PEDOT:PSS layer was formed on exposed portions of the ITO. The embodiment of the claimed solution was deposited on the PEDOT:PSS layer to form the substantially uniform active organic emissive polymer layer on the PEDOT:PSS layer.

As shown in FIG. 5, the prior art solution formed a layer that has a concave profile with a large amount of material at the edges of the banks. In contrast, the embodiment of the solution produced a layer having a substantially uniform and substantially flat profile, after accounting for the non-uniformity of the underlying layers, with only minimal material build up at the edges of the banks. As shown in FIG. 5, after accounting for the non-uniformity of the underlying layers, 70% of the width of the resulting organic emissive polymer layer is within a thickness variation of +5% (e.g., the resulting organic polymer layer is substantially uniform).

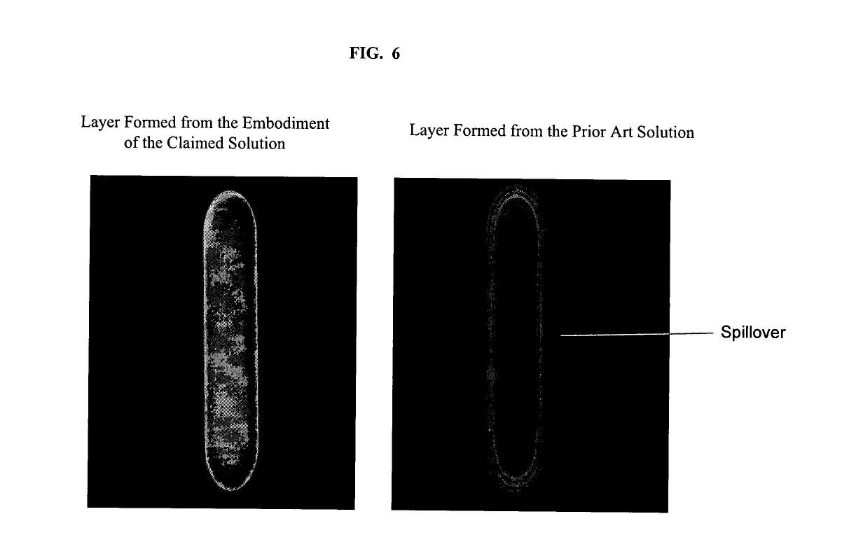

FIG. 6 shows photoluminescent images of the resulting layer formed by the prior art solution and the resulting layer formed by the embodiment of the solution according to the present invention. As shown in FIG. 6, the layer formed by the embodiment of the claimed solution is more uniform since this layer is represented primarily by a single intensity (different intensities represent different thickness). The layer formed by the prior art solution is represented by multiple intensities indicating nonuniformity. In addition, the layer formed from the embodiment of the claimed solution had less spillover from the pocket and this was partly due to the rapid gelling of the polymer solution and the resulting viscosity increase prevented the polymers from spilling over the pocket.

Second Electrode 323:

In one configuration of this embodiment, the second electrode layer 323 functions as a cathode. The cathode is typically a multilayer structure that includes, for example, a thin charge injection layer that has a lower work function and a thick conductive layer. The charge injection layer can be comprised of, for example, calcium or barium or mixtures thereof. The conductive layer can be comprised of, for example, aluminum, silver, magnesium, gold, copper, or mixtures thereof.

In an alternative configuration, the second electrode layer 323 functions as an anode. The anode, rather than the cathode, is deposited on the semiconductor stack 316 in the case of, for example, a top-emitting OLED. Typical anode materials are listed earlier in the section for the “first electrode 311”.

The thickness of the second electrode 323 is from about 10 nm to about 1000 nm, preferably from about 50 nm to about 500 nm, and more preferably, from about 100 nm to about 300 nm. The second electrode 323 can typically be fabricated using any of the techniques known in the art for deposition of thin films, including, for example, vacuum evaporation, sputtering, electron beam deposition, or chemical vapor deposition.

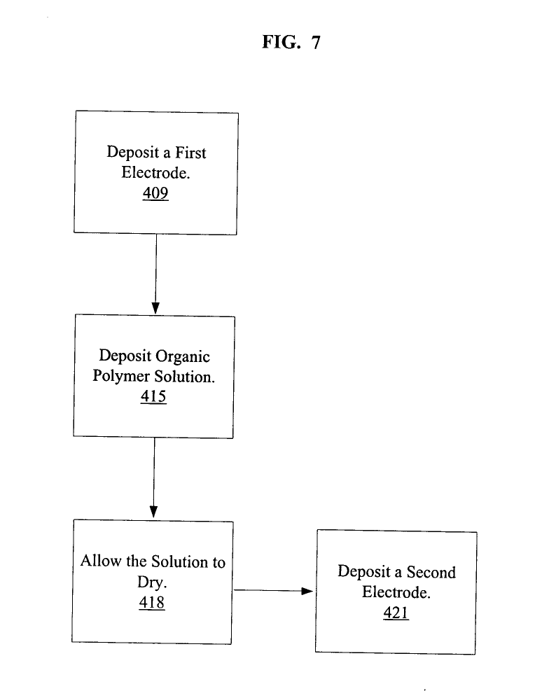

FIG. 7 shows a flowchart of an embodiment of a process to fabricate an organic electronic device according to the present invention. In block 409, a first electrode is deposited on a substrate. The first electrode can be deposited using, for example, vacuum evaporation, sputtering, electron beam deposition, or chemical vapor deposition. The first electrode can be patterned using techniques such as, for example, photolithography. A bank structure having an aperture can be formed on the first electrode. The bank structure can be formed by applying lithography techniques to a photo-resist material, or by using screen printing or flexo-graphic printing to deposit the photo-resist material in the desired pattern.

In block 415, an organic polymer solution is deposited on the first electrode. The organic polymer solution is made of organic polymers, a first solvent, and a second solvent. The first solvent has a high solubility (e.g., the first solvent dissolves at least about one weight percent of the organic polymers) and has a boiling point less than about 150° C.; and the second solvent has a very low solubility (e.g., the second solvent dissolves less than about one-fourth weight percent of the organic polymers) and has a boiling point greater than about 200° C. The solution can be deposited by, for example, ink jet printing where a nozzle of the ink jet printhead discharges one or more droplets of the solution into one of the apertures of the bank structures. Alternatively, the solution can be deposited by spin coating; in this case, an excess amount of the solution is deposited on the center of the substrate and then the device is rotated so that centrifugal force spreads the solution uniformly across the active area of the apertures of the bank structures. In addition, the solution can be deposited using screen printing or roll coating.

If the first electrode is an anode, then prior to depositing the organic polymer solution, a hole transporting material can be deposited on the anode to form the HTL; the HTL improves, for example, device efficiency. The HTL can be deposited using techniques such as, for example, spin coating, dip coating, roll coating, spray coating, thermal evaporation, screen printing, or ink jet printing. If the HTL layer is present, then the organic polymer solution is deposited on the HTL rather than the anode.

In block 418, the solution is allowed to dry in order to form the substantially uniform organic polymer layer. As the solution dries, the first solvent, due to its faster rate of evaporation than the second solvent, starts to evaporate from the solution, and soon after the first solvent starts to evaporate, the organic polymers, due to its lower solubility in the second solvent, rapidly falls out of solution and gels resulting in the substantially uniform organic polymer layer. By gelling rapidly, the rapid increase in local viscosity of the polymer solution substantially reduces the diffusion rate of the polymer, thus limiting the transport of the polymers and producing a substantially uniform (i.e., flat) organic polymer layer. As the solution dries, the second solvent also evaporates from the solution but it evaporates at a much slower rate than the first solvent.

The step of allowing the solution to dry may include raising the temperature of the solution by, for example, heating the underlying substrate and/or using a vacuum drying method. By raising the temperature of the solution or using a vacuum drying method (or a combination of both), the rate of evaporation of the first solvent and/or the second solvent is increased. By raising the temperature and/or applying a vacuum, the first solvent starts to evaporate sooner, and soon after the first solvent starts to evaporate, the organic polymers rapidly gels the solution resulting in the substantially uniform organic polymer layer. By raising the temperature of the solution by, for example, heating the underlying substrate, and/or by using the vacuum drying method, the solvents evaporate from the solution sooner thus the substantially uniform organic polymer layer is formed earlier thus lowering the total accumulated cycle (“TAC”) time.

In block 421, a second electrode is deposited on the substantially uniform organic polymer layer. The second electrode can be deposited using, for example, vacuum evaporation, sputtering, electron beam deposition, or chemical vapor deposition.

The OLED described earlier can be used within displays in applications such as, for example, computer displays, information displays in vehicles, television monitors, telephones, printers, and illuminated signs.

As any person of ordinary skill in the art of organic electronic device fabrication will recognize from the description, figures, and examples that modifications and changes can be made to the embodiments of the invention without departing from the scope of the invention defined by the following claims.

1. A method to fabricate an organic electronic device, comprising:
depositing a first electrode on a substrate;
depositing an organic polymer solution on said first electrode,
wherein said solution includes a first solvent, at least one organic polymer, and a second solvent, and
wherein said first solvent has a high solubility and a faster evaporation rate than said second solvent, and said second solvent has a very low solubility; and
allowing said solution to dry to form a substantially uniform organic polymer layer.

2. The method of claim 1 wherein
said first solvent dissolves at least about one weight percent of said plurality of organic polymers; and
said second solvent dissolves less than about one-fourth weight percent of said plurality of organic polymers.

3. The method of claim 1 wherein
said first solvent has a lower boiling point than said second solvent.

4. The method of claim 3 wherein
said first solvent has a boiling point less than about 150° C. and said second solvent has a boiling point greater than about 200° C.

5. The method of claim 1 wherein allowing said solution to dry includes
said first solvent evaporating from said solution and soon after said first solvent starts to evaporate, said solution rapidly gels resulting in said substantially uniform organic polymer layer.

6. The method of claim 1 wherein allowing said solution to dry includes
increasing a rate of evaporation of at least one of: (1) said first solvent and (2) said second solvent by at least one of: (1) raising a temperature of said solution and (2) applying a vacuum to said solution.

7. The method of claim 1 further comprising
prior to depositing said organic polymer solution, forming on said first electrode a bank having an aperture, wherein said organic polymer solution is deposited into said aperture, and said bank holds said deposited organic polymer solution.

8. The method of claim 1 further comprising
depositing a second electrode on said substantially uniform organic polymer layer.

9. The method of claim 1 wherein depositing said organic polymer solution includes ink jet printing or spin coating said organic polymer solution.

10. The method of claim 1 wherein
said first solvent is: toluene, chlorobenzene, ethyl benzene, xylene, cumene, anisole, or mesitylene; and
said second solvent is: decalin, tetramethyl benzene, N-methyl-pyrrolidone, pentyl benzene, gamma butyrolactone, alpha-terpineol, propylene, carbonate, or methylnaphthalene.

11. The method of claim 10 wherein said organic polymer is a polyfluorene or copolymers, derivatives, or combinations thereof.

12. The method of claim 10 wherein said organic polymer is a poly-p-phenylene vinylene or copolymers, derivatives, or combinations thereof.

13. The method of claim 10 wherein said organic polymer is a polyspiro or copolymers, derivatives, or combinations thereof.

14. The method of claim 7 wherein said solution further includes a third solvent, wherein said third solvent has a low surface tension so that said at least one organic polymer in said solution completely fills said aperture.

15. The method of claim 1 wherein said substantially uniform organic polymer layer has a thickness variation within +15% across 70% of a width of said layer.

16. The method of claim 1 wherein said organic electronic device is an OLED.

17. An organic electronic device, comprising:
a first electrode on a substrate;
a substantially uniform organic polymer layer on said first electrode; and
a second electrode on said substantially uniform organic polymer layer,
wherein said substantially uniform organic polymer layer is formed from a solution that includes a first solvent, at least one organic polymer, and a second solvent, and wherein said first solvent has a high solubility and a faster evaporation rate than said second solvent, and said second solvent has a very low solubility.

18. The device of claim 17 wherein
said first solvent dissolves at least about one weight percent of said plurality of organic polymers; and
said second solvent dissolves less than about one-fourth weight percent of said plurality of organic polymers.

19. The device of claim 17 wherein
said first solvent has a lower boiling point than said second solvent.

20. The device of claim 19 wherein
said first solvent has a boiling point less than about 150° C. and said second solvent has a boiling point greater than about 200° C.

21. The device of claim 17 further comprising
a bank on said first electrode, said bank includes an aperture into which said solution is deposited.

22. The device of claim 17 wherein
said first solvent is: toluene, chlorobenzene, ethyl benzene, xylene, cumene, anisole, or mesitylene; and
said second solvent is: decalin, tetramethyl benzene, N-methyl-pyrrolidone, pentyl benzene, gamma butyrolactone, alpha-terpineol, propylene, carbonate, or methylnaphthalene.

23. The device of claim 22 wherein said organic polymer is a polyfluorene or copolymers, derivatives, or combinations thereof.

24. The device of claim 22 wherein said organic polymer is a poly-p-phenylene vinylene or copolymers, derivatives, or combinations thereof.

25. The device of claim 22 wherein said organic polymer is a polyspiro or copolymers, derivatives, or combinations thereof.

26. The device of claim 17 wherein said substantially uniform organic polymer layer has a thickness variation within +15% across 70% of a width of said layer.

27. The device of claim 17 wherein said organic electronic device is an OLED.

28. A method to form a substantially uniform organic polymer layer on an object, comprising:
mixing at least one organic polymer in a first solvent and a second solvent to form an organic polymer solution, wherein said first solvent has a high solubility and a faster evaporation rate than said second solvent, and said second solvent has a very low solubility;
effectively depositing said solution on said object; and
allowing said solution to dry to form a substantially uniform organic polymer layer on said object.

29. The method of claim 28 wherein
said first solvent dissolves at least about one weight percent of said plurality of organic polymers; and
said second solvent dissolves less than about one-fourth weight percent of said plurality of organic polymers.

30. The method of claim 28 wherein
said first solvent has a lower boiling point than said second solvent.

31. The method of claim 30 wherein
said first solvent has a boiling point less than about 150° C. and said second solvent has a boiling point greater than about 200° C.

32. The method of claim 28 wherein effectively depositing said solution includes discharging said solution through a nozzle of an ink jet printhead such that said at least one organic polymer stays in solution during discharge.

33. The method of claim 28 wherein allowing said solution to dry includes
said first solvent evaporating from said solution and soon after said first solvent starts to evaporate, said solution rapidly gels resulting in said substantially uniform organic polymer layer.

34. The method of claim 28 wherein
said first solvent is: toluene, chlorobenzene, ethyl benzene, xylene, cumene, anisole, or mesitylene; and
said second solvent is: decalin, tetramethyl benzene, N-methyl-pyrrolidone, pentyl benzene, gamma butyrolactone, alpha-terpineol, propylene, carbonate, or methylnaphthalene.

35. The method of claim 32 wherein said organic polymer is a polyfluorene or copolymers, derivatives, or combinations thereof.

36. The method of claim 32 wherein said organic polymer is a poly-p-phenylene vinylene or copolymers, derivatives, or combinations thereof.

37. The method of claim 32 wherein said organic polymer is a polyspiro or copolymers, derivatives, or combinations thereof.

38. The method of claim 28 wherein said object is: a substrate, an electrode, or a hole transporting layer.

39. The method of claim 28 wherein said substantially uniform organic polymer layer has a thickness variation within +15% across 70% of a width of said layer.

40. An organic polymer solution, comprising:
at least one organic polymer;
a first solvent; and
a second solvent,
wherein said first solvent has a high solubility and a faster evaporation rate than said second solvent, and said second solvent has a very low solubility.

41. The solution of claim 40 wherein
said first solvent dissolves at least about one weight percent of said plurality of organic polymers; and
said second solvent dissolves less than about one-fourth weight percent of said plurality of organic polymers.

42. The solution of claim 40 wherein
said first solvent has a lower boiling point than said second solvent.

43. The solution of claim 42 wherein
said first solvent has a boiling point less than about 150° C. and said second solvent has a boiling point greater than about 200° C.

44. The solution of claim 40 wherein said solution is deposited on an object and allowed to dry to form a substantially uniform organic polymer layer on said object, wherein said object is: a substrate, an electrode, or a hole transporting layer.

45. The solution of claim 40 wherein as said solution dries, said first solvent evaporates from said solution and soon after said first solvent starts to evaporate, said solution rapidly gels resulting in said substantially uniform organic polymer layer.

46. The solution of claim 40 wherein
said first solvent is: toluene, chlorobenzene, ethyl benzene, xylene, cumene, anisole, or mesitylene; and
said second solvent is: decalin, tetramethyl benzene, N-methyl-pyrrolidone, pentyl benzene, gamma butyrolactone, alpha-terpineol, propylene, carbonate, or methylnaphthalene.

47. The solution of claim 46 wherein said organic polymer is a polyfluorene or copolymers, derivatives, or combinations thereof.

48. The solution of claim 46 wherein said organic polymer is a poly-p-phenylene vinylene or copolymers, derivatives, or combinations thereof.

49. The solution of claim 46 wherein said organic polymer is a polyspiro or copolymers, derivatives, or combinations thereof.

50. The solution of claim 40 wherein said substantially uniform organic polymer layer has a thickness variation within +15% across 70% of a width of said layer.
